(19) United States
(12) Patent Application Publication
(10) Pub. No.: US 2017/0028671 A1
(43) Pub. Date: Feb. 2, 2017

(54) STEPPED INTERMEDIATE LAYER (LAMINATED TOLERANCE COMPENSATION SHEET)

(71) Applicant: Georg Martin GMBH, Dietzenbach (DE)

(72) Inventor: Christoph Martin, Dietzenbach (DE)

(73) Assignee: Georg Martin GMBH, Dietzenbach (DE)

(21) Appl. No.: 15/303,106

(22) PCT Filed: Apr. 15, 2015
(86) PCT No.: PCT/EP2015/058127

§ 371 Date: Oct. 10, 2016

(30) Foreign Application Priority Data
Apr. 17, 2014 (DE) 20 2014 003 326.9

(51) Int. Cl. B32B 3/26; B32B 5/02; B32B 5/24; B32B 27/08; F16B 11/00; B32B 37/14; B32B 37/10; B32B 37/12; B32B 3/30; B32B 27/06; B32B 7/12

(52) U.S. Cl. CPC B32B 3/266; B32B 27/06; B32B 5/024; B32B 5/24; B32B 27/08; B32B 7/12; B32B 37/14; B32B 37/10; B32B 37/12; B32B 3/30; F16B 11/006; B32B 2309/105; B32B 2305/72

(57) ABSTRACT

The present invention relates, in general, to stepped intermediate layers (laminated tolerance compensation sheets), having a thickness that can be adapted by splitting layers, for adjusting elements for mechanical constructions.

### BACKGROUND OF THE INVENTION

The present invention relates, in general, to stepped intermediate layers (laminated tolerance compensation sheets), having a thickness that can be adapted by splitting layers, for adjusting elements for mechanical constructions.

In detail, in a first embodiment, the invention relates to a laminated intermediate layer (laminated tolerance compensation sheet) having a thickness that can be adapted by splitting layers, wherein this product includes an optionally alternating layering of sheet elements (flat material sheet) and optionally layers of an adhesive material.

These so-called peelable materials are widely used as thickness shims in complex mechanical constructions, in particular in aeronautics. These constructions may consist of several hundred or even thousands of parts, each of which has its own dimensional tolerances. The sum total of the tolerances creates play which can in some cases be considerable, several millimeters, for which it is necessary to compensate in order to assure correct functioning of mechanical constructions.

To this end, intermediate layers (adjusting elements) of metallic or polymeric materials are used, which are most often peelable. These peelable intermediate layers (shims) are composed of thin lamellae that are stacked with glue between them to a greater or lesser thickness, and machined so as to adapt to the outer contour of the items to be adjusted. Adjustment is carried out through reduction in the thickness of the intermediate layer (shim) by peeling off one or more of these layers and inserting the intermediate layer (shim) in the place where play was determined to exist.

EP 667 233 A describes peelable intermediate layers (adjusting elements) comprising a number of sheet elements (flat material sheet), between any two of which adhesive layers are inserted. The sheet elements (flat material sheet) are made of metal or optionally of plastic.

U.S. Pat. No. 4,526,641 A describes an intermediate layer (shim) consisting of a layering of thermally curing sheet elements (flat material sheet) bonded together by means of an adhesive of similar type, characterized by some intralaminar cohesive force.

DE 602 08 922 T2 relates to a laminated product (an intermediate layer) featuring a thickness that can be adjusted by exfoliation, a process for the preparation thereof, and the use thereof for producing shims. For this purpose, the product features alternating layering of flat material sheets (sheet elements) and layers of an adhesive material, where each flat material sheet (sheet elements) has an intrinsic resistance to tearing, and each layer of adhesive material connects two flat material sheets (sheet elements) adjacent to each other in the pile by an associative force that is weaker than the resistance of the flat material sheets (sheet elements) to tearing, so that each flat material sheet (sheet element) can be detached from the stack without being torn. This product is essentially characterized in that the flat material sheet (sheet elements) is essentially made of woven fibers, and that the flat material sheet (sheet elements) of each pair of flat material sheets (sheet elements) adjacent to the same common layer of adhesive is impregnated throughout its thickness with a mass of adhesive material, which forms a unit with the common layer of adhesive. In this respect, the full disclosure of this document is incorporated herein by reference.

The company Jicey and Lameco proposes intermediate layers (laminated tolerance compensation sheets) that have sheet elements (flat material sheets) of two different thicknesses and distinguishable in color.

The precited prior art documents have in common that the individual sheet elements (flat material sheets) have the same thickness throughout the area in a given system, irrespective of whether they are made of metal, polymer sheet or a fabric. The combination of a plurality of sheet elements (flat material sheets) of a first thickness with a plurality of sheet elements (flat material sheets) of a second thickness can be produced only with a considerable expense. However, oblique running gaps can only insufficiently be compensated uniformly.

### SUMMARY OF THE INVENTION

In this connection, it is a first object of the invention to propose terraced or stepped intermediate layers (laminated tolerance compensation sheets) that eliminate the above described difficulties in non-parallel gaps.

In a first embodiment, the above object is achieved by a laminated intermediate layer for tolerance compensation with several individual sheets, characterized in that
the respective individual sheet is separated into individual ribbed surface elements, the separation of the surface elements runs perpendicular to the plane of the sheets, wherein
the lower side of the lowermost individual sheet is laminated over its full area with a cover sheet, which extends in the form of a book spine to the top side of the topmost individual sheet, with which it is adhesively bonded over its full area or in parts.

By the term “individual ribbed surface elements,” it is meant that the individual sheets are weakened by perforations for separating each of the surface elements wherein the surface elements are individually separated into single pieces.

### DETAILED DESCRIPTION OF THE INVENTION

FIG. 1 describes the lower side of a laminated intermediate layer for tolerance compensation with bores 2a, 2b, 2c positioned in an exemplary way, which may be subdivided into individual stepped surface elements 3a, 3b, 3c, 3d, 3e, 3f, 3g, 3h, 3i and 3j along the dotted lines, or may be integral.

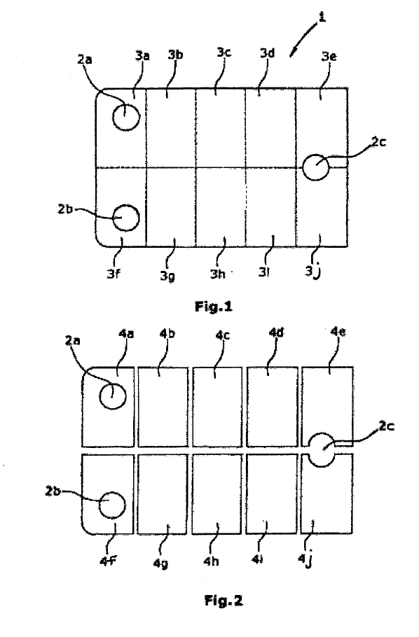

FIG. 2 shows the individual surface elements 4a, 4b, 4c, 4d, 4e, 4f, 4g, 4h, 4i and 4j. These are fixed on the basis according to FIG. 1 in separate blocks, or cut out of the individual sheets afterwards. Accordingly, the separation of the surface elements 4a, 4b, 4c, 4d, 4e, 4f, 4g, 4h, 4i and 4j runs perpendicular to the plane of the sheet elements.

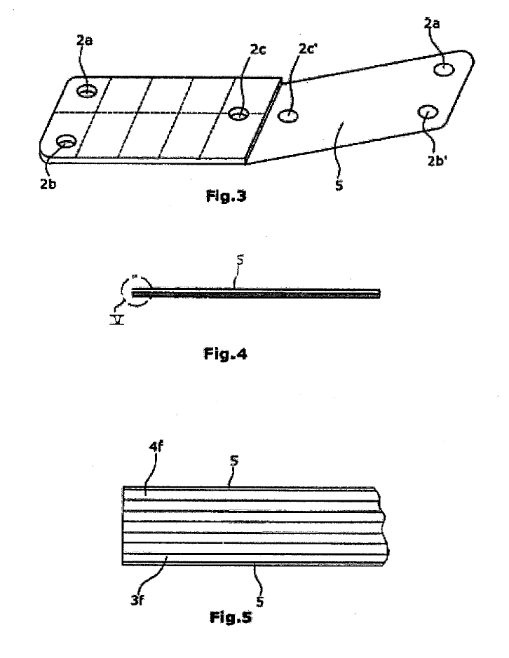

FIG. 3 shows that the sheets/surface elements 4a, 4b, 4c, 4d, 4e, 4f, 4g, 4h, 4i and 4j are laminated with a cover sheet 5, which extends in the form of a book spine from the lower side of surface elements 3a, 3b, 3c, 3d, 3e, 3f, 3g, 3h, 3i and 3j to the top side of the topmost individual sheet, with which it is adhesively bonded over its full area or in parts.

FIG. 4 shows the book-like design of the laminated intermediate layer for tolerance compensation by the black boundary line and the individual sheets. FIG. 5 shows a magnification of section V of FIG. 4, in which the shown regions of sheets 3f and 4f are covered by cover sheet 5. Cover sheet 5 stabilizes the sheet stacks.

If the cover sheet is removed from the individual sheets 4a, 4b, 4c, 4d, 4e, 4f, 4g, 4h, 4i and 4j, the individual surface elements of the individual sheets can be removed, and thus a stepped or terraced arrangement, for example, can be achieved. After the removal, for example, by peeling or pulling off, a terraced or stepped intermediate layer can thus be obtained. Then, for assembly, the cover sheet 5 may again be applied to the topmost layer of the individual sheets 4a, 4b, 4c, 4d, 4e, 4f, 4g, 4h, 4i and 4j, and adhesively bonded with it.

The individual sheets of the laminated intermediate layer according to the invention including tolerance compensation have a thickness of from 0.1 mm to 0.025 mm. However, any other thicknesses of the individual sheets may also be provided, all of which need not necessarily have the same thickness.

According to the present invention, it is particularly preferred to adhesively bond the individual sheets to each other, and to adhesively bond the cover sheet 5 to the topmost and/or lowermost individual sheet over its full area or in parts.

In practice, it is often found that a full-area bonding between the surface elements may be disadvantageous if the intermediate layers (tolerance compensation intermediate layers) are employed between two curved components. In addition, a full-area bonding may occasionally be disadvantageous when individual sheet elements are peeled off, because usually a tool would have to be used. In part, it is further disadvantageous that the pulled off layers in metallic intermediate layers (tolerance compensation intermediate layers) curl up and immediately become rejects, thus representing a risk that the whole intermediate layer could become rejects if too much is drawn off.

According to the invention, this drawback can be overcome by providing an intermediate layer having a thickness that can be adapted by splitting layers from a layering of sheet elements, wherein each sheet element consists of a film of constant thickness, and the sheet elements have equal or differing thicknesses, and the sheet elements 3e, 3j and 4e and 4j are partially or completely bonded together with an adhesive through their front sides (book spine bonding).

Another advantageous embodiment of these intermediate layers with different or also with equal thicknesses of the sheet elements can be achieved by providing products with adhesive only in partial areas of the sheet elements lying flat on one another.

All bonding methods have in common that they are redetachable or recleavable.

Applying the sheet elements 4a to 4j to a flexible and bendable base plate as in FIG. 1 can prove advantageous for curved surfaces of the constructions. In addition, the partial bonding enables a flexible radius design for curved surfaces whenever two curved surfaces must be kept at a distance in applications. Also, different types of materials can be bonded together with a wide variety of advantageous properties for the application, such as: avoiding contact corrosion, introducing sliding layers, integrating thicker sheet elements (interior material sheets), which introduce stiffness and higher pressure strengths and offer advantages in cost by reducing the number of layers.

In particular, achieving an increase of compressive rigidity in an intermediate layer without a solid thicker core can be very advantageous, for example, from a structure of many layers in combination with a few thin ones, for example, 2 mm=six times 0.3 mm plus two times 0.1 mm, because the construction of the intermediate layer then need not calculate a minimum distance in the height of the solid fraction. Thus, a space-saving fully laminated construction with a high compressive rigidity can be realized. Especially in the improvement of existing constructions, for example, where spacer elements are provided that still have to be ground, where tolerance intermediate layers are to be introduced afterwards, this can be of space-saving advantage.

According to an advantageous embodiment of the process, the process for providing the sheet elements with an adhesive can be effected by atomizing, by applying manually by means of a roller, by printing on a machine of the “offset” type, or by dipping.

In an embodiment according to the invention, the adhesive is a synthetic rubber and/or a resin, for example, an optionally water-based acrylate, epoxy, phenol, vinyl ester or polyvinyl resin, which holds the sheet elements together by a polymerization process.

According to an advantageous embodiment of the product according to the invention, the rubber and/or the resin may be provided with additives to form the adhesive, such additives being curing agents and/or diluants for changing the viscosity of the adhesive.

According to an advantageous embodiment of the product according to the invention, the adhesive may comprise from 40% to 60% of the volume of the product before the polymerization process.

According to an advantageous embodiment of the product according to the invention, the resin may be provided with additives to form the adhesive, such additives being curing agents and/or diluants for changing the viscosity of the adhesive.

According to an advantageous embodiment of the product according to the invention, the adhesion between adjacent sheet elements (flat material sheets) is reduced by increasing the amount of diluant as compared to the amount of resin in the adhesive.

According to an advantageous embodiment of the product according to the invention, the additive may comprise more than 50% of the volume of the adhesive before the polymerization process.

The intermediate layer (laminated tolerance compensation sheet) according to the present invention is a time- and cost-optimized alternative to known intermediate layers of a low thickness for non-parallel gaps. Naturally, the preparation of intermediate layers (laminated tolerance compensation sheets) of the same total thickness depends on the number of the individual sheet elements (flat material sheets). The more sheet elements (flat material sheets) are contained for the same total layer thickness, the thinner one sheet element (flat material sheet) has to be designed accordingly, which leads to higher cost when the individual sheet elements (flat material sheets) have a lower thickness.

For certain very low thicknesses of the sheet elements (flat material sheets), it is possible to peel them off with a finger instead of a tool, so that this is also to be considered an advantage relating to the handling of the sheets. This is achieved by partially peeling a small piece of the sheet on the side of the thin sheet elements in the finished product in advance by the manufacturer. Thus, this serves the user as a kind of “finger lift” for starting to peel this side without a tool. At the same time, the thin sheet elements can also be distinguished from the thicker ones, because said peeling in advance is effected only on the thin side by definition. In addition, the distinction is supported by printing an optical mark, for example, three parallel lines, on the side of the finger lift.

More preferably according to the present invention, the sheet elements are metallic foils, polymer sheets, fiber composite materials, woven fabrics and/or nonwovens made of fibers, essentially glass, carbon, ceramic or aramide fibers or a mixture of different materials. These can be combined with one another arbitrarily. It may be preferred to provide the intermediate layers with at least two kinds of sheet elements of different thicknesses. More preferably according to the present invention, the ratio of the thickness of a first kind of sheet elements to the thickness of a second kind of sheet elements is from 10:2 to 10:7, especially from 10 to 5, i.e., the individual sheet elements are half as thick as the other sheet elements. For example, it is possible to provide the first kind of sheet elements with a thickness of 0.05 mm, while the thickness of the second kind of sheet elements (flat material sheets) is 0.025 mm (10 to 5), for example. Thus, it is possible to perform a tolerance compensation of either 0.05 mm or 0.025 mm at a given time when the intermediate layers (laminated tolerance compensation sheets) are used accordingly.

By the combination of thin and thicker layer thicknesses, it may be particularly skilful in the case of wishing to use composites (polymer or fiber composites) to enable even very low adjusting intervals, which have the drawback of a high flexibility when composites are used. In the embodiment according to the invention, usual thicknesses of composite layers can now be combined with very thin layers, formed from metal foils of less than 0.050 mm, for example. The advantage is based on the effect that the stiffness of thin composite layers is more and more influenced by the relatively flexible resin as the thickness decreases.

According to the present invention, it may be essential that the surface between two sheet elements is not completely covered with adhesive, as has been usual in the prior art. If in the present case it is defined that only 10 to 50% of the surface of a sheet element is covered by the adhesive, this means that the remaining areas of the sheet elements lie on one another freely and without a bonding contact. The free mobility in these areas enables individual sheet elements to be separated particularly easily and without the use of tools, only using a finger. In a non-generic prior art product, this basic principle has been realized in the production of adhesive notes (Post-It®). However, according to the invention, it is not required, although possible, to bond together the front sides of the sheet elements as well.

Instead of applying the adhesive between the sheet elements in a single spot, which is naturally increased accordingly when the sheet elements are pressed together, of course it is also possible to apply the adhesive in a large number of small spots to form a raster-like arrangement of such spots. This raster-like arrangement may extend throughout the surface of individual sheet elements, in which is it necessary, however, to observe the limits of surface covering as set forth above. Alternatively, however, it is also possible to limit the raster-like arrangement of the adhesive to particular predetermined areas.

Another advantage of the embodiment according to the invention resides in the fact that peeled-off intermediate layers can be reused. Especially in metallic laminated intermediate layers, this fact is not to be neglected, because “too much” peeling thus cannot take place, because a peeled-off layer retains its shape rather than curling up and becoming waste. Thus, at any rate, the amount of rejects, which may result from normal handling, is also reduced. This speaks very much in favor of the “one component” solution because rejects need not be taken into account.

A process for preparing an intermediate layer having a total thickness that can be adapted by splitting layers consists in a layering process in which an alternate layering of sheet elements and optionally adhesive is formed, wherein sheet elements of a first and of a second thickness are selected, and at least one first sheet element of a first thickness is provided partially or entirely with an adhesive on at least one surface thereof, pressing is optionally performed, a second sheet element is placed on the adhesive surface, pressing is optionally performed, the now exposed surface of the second sheet element is provided with an adhesive by analogy with the first sheet element, and these process steps are repeated until the total thickness of the intermediate layer is reached, wherein sheet elements (sheets) of the second thickness are employed (joker sheet) instead of the sheet elements of the first thickness within the repeating steps.

In the case where a woven fabric is employed instead of a sheet, the process also includes a layering process in which a woven fabric is selected as a sheet element and impregnated with an adhesive throughout the surface and thickness thereof.

Another process for preparing an intermediate layer having a total thickness that can be adapted by splitting layers consists in providing the front sides of a layering of sheet elements with an adhesive by analogy with a book spine, optionally after roughening them. Then, in a second step, the adhesive is cured. Alternatively, it is also possible to dip a loose or compressed layering of sheet elements into a bath with the adhesive, or to spray the front sides of the sheet elements with the adhesive.

Thus, the intermediate layers with different, but also with equal, thicknesses of the sheet elements are provided with an adhesive only in partial areas of the sheet elements, which is effected only at the periphery, i.e. the front sides, of the sheet elements.

All the embodiments of the present invention have in common that they may also comprise the variant that the intermediate layer may have only one sheet element (sheet) of a lower thickness on one surface of the intermediate layer (joker sheet).

According to another embodiment, the invention relates to the peelable adjusting elements for mechanical constructions of non-parallel gaps.

Therefore, it is particularly preferred to cut or punch out the individual sheet elements (layers) in the form of the end product, in order to stack them exactly on one another. Subsequently, the layers are fixed, and then, the previously defined front side(s)/peripheral edge(s) are provided with the adhesive. The adhesive should be elastic enough to offer mechanical strength for a low use area, and to resist the shocks from handling and transport.

1. A laminated intermediate layer for tolerance compensation with several individual sheets, characterized in that
the respective individual sheet is separated into individual ribbed surface elements, the separation of the surface elements runs perpendicular to the plane of the sheets, wherein
the lower side of the lowermost individual sheet is laminated over its full area with a cover sheet, which extends in the form of a book spine to the top side of the topmost individual sheet, with which it is adhesively bonded over its full area or in parts.

2. The intermediate layer according to claim 1, characterized in that the individual sheets have a thickness of from 0.1 mm to 0.025 mm.

3. The intermediate layer according to claim 1, characterized in that the individual sheets to one another, and the cover sheet to the topmost and/or lowermost individual sheet, are adhesively bonded over their full area or in parts.

4. The intermediate layer according to claim 1, characterized in that the cover sheet and the individual sheets have one or more congruent bores.

5. A process for preparing an intermediate layer according to claim 1, characterized in that a cover sheet is provided with an adhesive on one side thereof, a first sheet element is laid on the adhesive area, pressing is performed, the exposed surface of the first sheet element is provided with an adhesive over its full area or in parts on its exposed surface, a third sheet element is laid on the adhesive area, pressing is performed, the now exposed surface of the third sheet element is provided with an adhesive by analogy with the second sheet element, and these process steps are repeated until the total thickness of the intermediate layer is reached.

6. A process for preparing an intermediate layer according to claim 1, comprising roughening the front sides of said bonded layering of sheet elements, which comprises sheet elements of a first thickness and sheet elements (sheets) of second thickness, which are partially or completely separated into individual ribbed surface elements, the front side is provided with an adhesive, or a loose or compressed layering of the sheet elements is dipped into a bath with the adhesive, or the front side of the sheet elements is sprayed with an adhesive, and in a second step, the layering is covered with a cover sheet, which extends in the form of a book spine from the outer side of the first sheet element to the top side of the topmost individual sheet, and the adhesive is cured.

7. A process for preparing an intermediate layer according to claim 5, wherein sheet elements (sheets) of said second thickness are employed instead of the sheet elements of the first thickness within the repeating steps, which are partially or completely separated into individual ribbed surface elements, and wherein said cover sheet extends in the form of a book spine to the top side of the topmost individual sheet
